(19) United States
(12) Patent Application Publication
(10) Pub. No.: US 2003/0182004 A1
(43) Pub. Date: Sep. 25, 2003

(54) Electronically-accessible product description

(76) Inventors: James Darrow Linder, Placentia, CA (US); Xuqiang Wu, Irvine, CA (US)

Correspondence Address: FISH & RICHARDSON P.C., 1425 K STREET, N.W., 11TH FLOOR, WASHINGTON, DC, 20005-3500, US

(21) Appl. No.: 10/103,123

(22) Filed: Mar. 22, 2002

(51) Int. Cl. G06F 19/00

(52) U.S. Cl. 700/97

(57) ABSTRACT

A method of describing products in an electronically-accessible format includes receiving a product geometry description to describe the geometry of a portion of a product, receiving a product attribute description to describe a non-geometric attribute of the portion of the product, and storing the product geometry description and the product attribute description in an electronically-accessible format.

### BACKGROUND

This disclosure relates to describing products in an electronically-accessible format.

Computers and other electronic systems have been used to describe products in a variety of applications. For example, CAD, CAM, and CAE software systems allow users to create and edit geometric designs of products. The geometric information may also be stored and transmitted electronically to speed and improve design and manufacturing processes.

### SUMMARY

Geometric designs provide an incomplete description of many products. In particular, geometric designs lack non-geometric information, hereinafter referred to as attribute information, examples of which include product finish, product assembly information, product weld information, product tolerances, product constituent material, product constituent material processing, product texture, and product color. By including non-geometric information in an electronically-accessible product description, the design and manufacture of products can be sped and improved.

For example, if one surface of a product part requires a particular finish, then information describing the finish may be included in the electronically-accessible product description. The product description may then be provided to manufacturing software that electronically accesses the finish description and selects tooling capable of developing the finish on the product.

Tools for describing a product may be produced to support the creation, editing, navigation, and/or visualization of an electronically-accessible, non-geometric, product description. A user is able to define product attributes that capture non-geometric product information and associate this non-geometric information with geometric information in an electronically-accessible model. Benefits of this may include the ability to electronically access an engineering knowledge base that already exists in external and internal databases during the design and manufacturing process, the ability to embed non-geometric product information within a geometric model, the ability to display non-geometric information and make it accessible to other applications, including third party applications, the ability to extend products by custom modeling features that are controlled by rules, and the ability to integrate engineering knowledge across different applications for analysis and design purposes. Other applications that may electronically access the non-geometric product information include CAM packages and tolerance analysis applications.

In one general aspect, describing a product in an electronically-accessible format includes receiving a product geometry description to describe the geometry of a portion of a product, receiving a product attribute description to describe a non-geometric attribute of the portion of the product, and storing the product geometry description and the product attribute description in an electronically-accessible format. The product attribute description may be determined based on a design rule.

In another general aspect, describing a product in an electronically-accessible format includes receiving a product geometry description to describe the geometry of a portion of a product, receiving a product attribute description to describe a non-geometric attribute of the portion of the product, receiving a product attribute display instance to describe how the product attribute description is to be displayed, storing the product geometry description, the product attribute description, and the product attribute display instance in an electronically-accessible format, and displaying the product attribute description adjacent a product geometry display in accordance with the product attribute display instance.

In another general aspect, describing a product in an electronically-accessible format includes receiving a product geometry description to describe the geometry of a portion of a product, receiving a definition of a non-geometric attribute of the portion of the product from a user, receiving a product attribute description to describe the non-geometric attribute, and storing the product geometry description and the product attribute description in an electronically-accessible format.

In another general aspect, describing a product in an electronically-accessible format includes receiving a product geometry description to describe the geometry of a portion of a product, receiving a product attribute description to describe a predefined non-geometric attribute of the portion of the product, and storing the product geometry description and the product attribute description in an electronically-accessible format.

Implementations of these and other aspects may include one or more of the following features. For example, the product attribute description may be received from another computer system. The product attribute description may be a numerical value of the non-geometric attribute described by the product attribute description. The design rule may bound a range of potential numerical values of the product attribute description, and may provide a list of potential product attribute descriptions.

Receiving the product attribute description may include receiving a copy of a previous product attribute description. The previous product attribute description may describe a non-geometric attribute of a previous version of the portion of the product. The product attribute description also may be determined based on one of the product geometry description and another product attribute description.

The product attribute description may be determined based on the design rule. The product attribute description may describe a finish, an assembly, a weld, a tolerance, a constituent material, a texture, or a color of the portion of the product.

The product attribute description may be accessed electronically and used to select a condition or process for manufacturing the portion of the product, or to select a tool for manufacturing the portion of the product. The portion of the product may be a surface of the product or the product itself. A second product attribute description that describes a second non-geometric attribute of the portion of the product also may be received. The second product attribute description may be stored in the electronically-accessible format. A second product geometry description that describes the geometry of a second portion of the product also may be received and stored in the electronically-accessible format.

A navigable chart including the product attribute description and the second product attribute description may be displayed and a selection signal identifying at least one of the product attribute descriptions may be received. An edit to at least one of the product attribute descriptions may be received and incorporated into the respective stored description.

A status of the portion of the product may be displayed. The displayed status may include an indicator that the portion of the product is complete or inactive. A reason as to why the portion of the product is inactive may also be displayed, as may be a name of another portion having the product geometry description.

A potential attribute of the portion of the product to be described by the product attribute description may be displayed. A definition of the non-geometric attribute may be received from a user. The product may be manufactured based on the electronically-accessed product geometry description and the product attribute description.

The product geometry display may be changed while the display of the product attribute description is maintained. A second product attribute description may be displayed adjacent the product geometry display.

One of the product attribute descriptions may be removed from adjacent the product geometry display. A lead line may be displayed between the product attribute description and the portion of the product. Basing the display of the product attribute description on the product attribute display instance may include displaying a symbol. The status of the portion of the product may also be displayed.

The definition of the non-geometric attribute may include a data class of the product attribute description of the non-geometric attribute. The definition of the non-geometric attribute may also include a design rule that determines the product attribute description of the non-geometric attribute. The product attribute description may be in a predetermined data class.

The details of one or more implementations are set forth in the accompanying drawings and description. Other features and advantages will be apparent from the description and drawings, and from the claims.

### DESCRIPTION OF DRAWINGS

FIG. 1 is a block diagram of a programmable system for describing and accessing an electronically-accessible product description.

FIG. 2 is a flow chart of a process flow for describing and accessing a product in an electronically-accessible format.

FIG. 3 is a flow chart of a process flow for describing a product.

FIG. 4 is a data structure of a product definition describing a product, including the attributes described during the process flow of FIG. 3.

FIG. 5 is a flow chart of a process flow for creating product definitions.

FIG. 6 is a screen capture of a product definition editor before the creation of product definitions.

FIG. 7 is a screen capture of a navigation tree of existing product definitions.

FIG. 8 is a flow chart of a process flow for displaying and editing a representation of a product.

FIG. 9 is a representation of a product.

FIG. 10 is another representation of the product of FIG. 9.

Like reference symbols in the various drawings indicate like elements.

### DETAILED DESCRIPTION

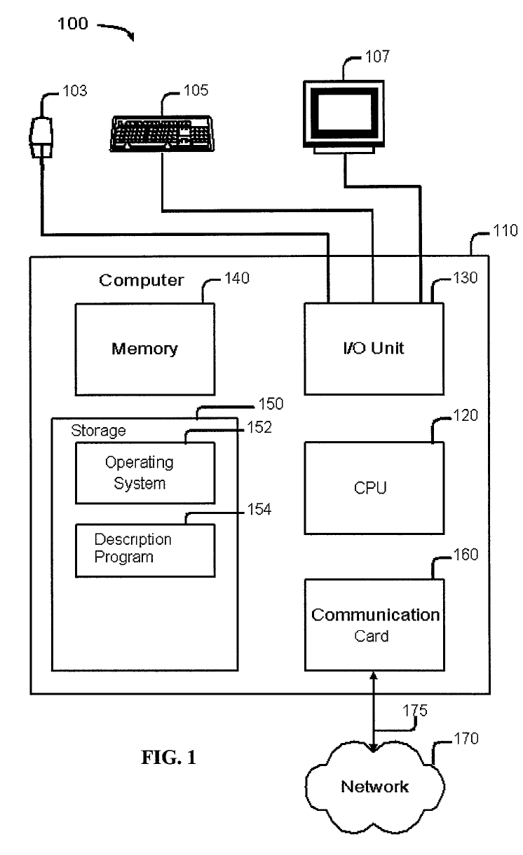

Referring to FIG. 1, a programmable system 100 for describing and accessing an electronically-accessible product description includes a variety of input/output (I/O) devices (e.g., mouse 103, keyboard 105, and display 107) and a computer 110 having a central processor unit (CPU) 120, an I/O unit 130, a memory 140, and a data storage device 150. Data storage device 150 may store machine-executable instructions, data, and various programs such as an operating system 152 and one or more description programs 154 for describing and accessing an electronically-accessible product description, all of which may be processed by CPU 120. Each computer program may be implemented in a high-level procedural or object-oriented programming language, or in assembly or machine language if desired; and in any case, the language may be a compiled or interpreted language. Data storage device 150 may be any form of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM).

System 100 also may include a communications card or device 160 (e.g., a modem and/or a network adapter) for exchanging data with a network 170 using a communications link 175 (e.g., a telephone line, a wireless network link, a wired network link, or a cable network). Other examples of system 100 may include a handheld device, a workstation, a server, a device, a component, other equipment, or some combination of these capable of responding to and executing instructions in a defined manner. Any of the foregoing may be supplemented by, or incorporated in, ASICs (application-specific integrated circuits).

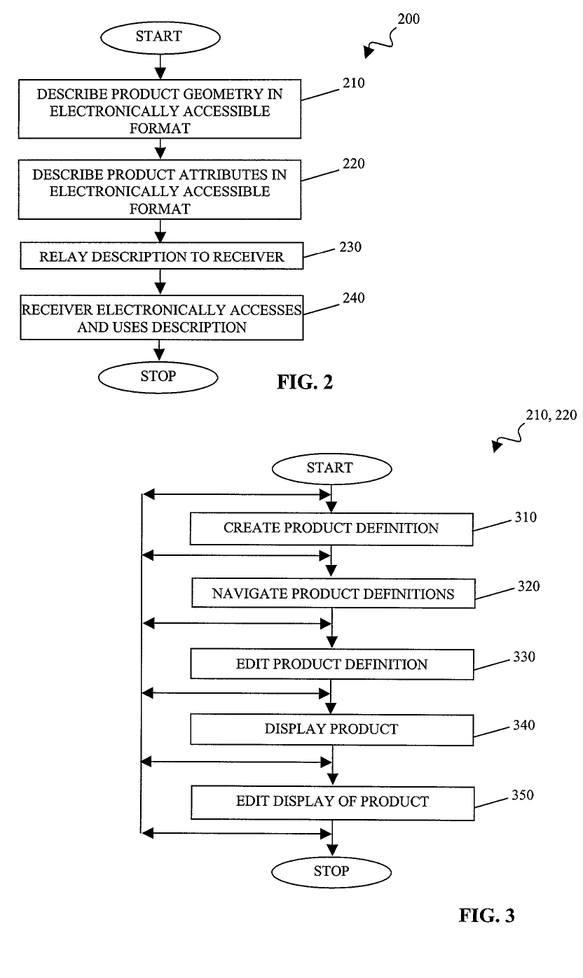

FIG. 2 illustrates a process flow 200 for describing and accessing a product description in an electronically-accessible format. The geometric characteristics of the product are described in an electronically-accessible format (step 210), as are the non-geometric product attributes (step 220). The electronically-accessible format may be, for example, a data record or other computer readable arrangement. The geometric characteristics and the product attributes then are relayed to a receiver by, for example, transmitting, copying, or otherwise broadcasting the product description (step 230). The product description is then accessed electronically and used by the receiver (step 240). Including non-geometric product attributes in the electronically-accessible product description permits the receiver to electronically access additional information about the product. This additional information may be used, for example, to rapidly and accurately select conditions, processes, and/or tools for manufacturing the described product.

Referring to FIG. 3, a process flow 210, 220 for describing the geometry and attributes of a product or a portion of a product begins with the creation of a new product definition (step 310). A product definition is an electronically-accessible representation of the name, geometry, attributes, and other characteristics of a product or a portion of a product. Several product definitions may be created on a single system, and a user may navigate through the product definitions (step 320) by, for example, selecting a particular product definition from a list of product definitions. The user also may edit the product definition (step 330) as needed. The system also creates a graphical display of a product described by a product definition (step 340), and permits the user to edit the display of the product as needed (step 350).

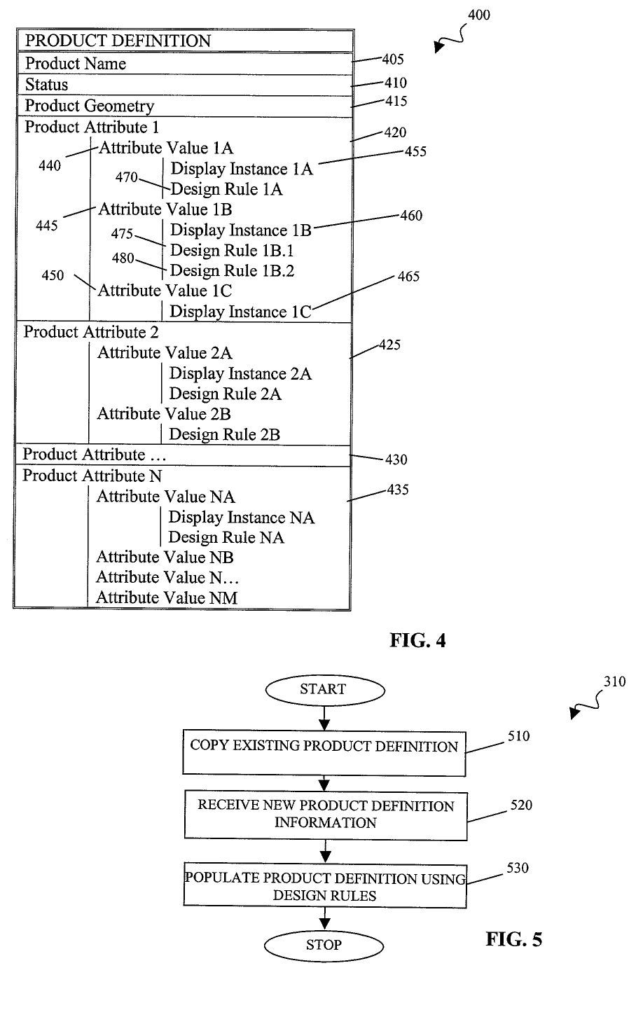

Referring to FIG. 4, a product definition database 400 includes a product name record 405, a status record 410, one or more product geometry records 415, and one or more product attribute records 420, 425, 430, 435. Product name record 405 contains electronically-accessible information encoding a product name. Status record 410 contains electronically-accessible information encoding the status of a product. Status information may include, for example, whether product definition 400 is complete, whether product definition 400 is retained or inactive, one or more reasons why product definition 400 is retained or inactive, and the name or status of one or more other product definitions with the same geometry as the product definition 400.

Product geometry record 415 contains electronically-accessible information encoding a geometric description of the product. Geometry record 415 may be accessible electronically using, for example, the PARASOLID Version 13.0 geometric modeler available from Unigraphics Solutions Inc. of Cypress, Calif. Product attribute records 420, 425, 430, 435 contain electronically-accessible information encoding data that provides non-geometric attribute information about the product described by product definition database 400. Product attribute records 420, 425, 430, 435 may contain, for example, electronically-accessible information encoding the product finish, product assembly information, product weld information, product tolerances, product constituent material, product constituent material processing, product texture, or product color.

Product attribute record 420 includes three attribute values 440, 445, 450. Attribute values 440, 445, 450 may be single values of different data types that describe the product attribute. For example, if product attribute record 420 encodes the constituent material of the product, attribute value 440 may encode for stainless steel, attribute value 445 may encode for the processing of the steel (for example, whether the processing includes a heat treatment or annealing), and attribute value 450 may encode for the iron content of the steel. Each attribute value 440, 445, 450 may also include data encoding display characteristics of the attribute value (for example, display instances 455, 460, 465) and data encoding design rules or links to design rules (for example, design rules 470, 475, 480).

The display characteristics encoded in display instances 455, 460, 465 may include, for example, the size, color, positioning, symbology, font, and the desirability of a representation of the information encoded by product attribute records 420, 425, 430, 435 on an engineering drawing or other display. For example, display instance 455 may indicate that no representation of Attribute Value 1A is desired, whereas display instance 460 may indicate that Attribute Value 1B is to be displayed on the lower left side of an engineering drawing in small, boldface type with a lead line to a selected portion of the product in the engineering drawing.

The design rules or links to design rules encoded in design rules 470, 475, 480 may be used to determine the respective attribute value or to bound the range of the respective attribute value. Design rules 470, 475, 480 may also be used to incorporate a technical knowledge base into the product description process. For example, Design Rule 1A 470 may encode a list of potential constituent materials for the product, while Design Rule 1B.1 475 may encode a list of potential coverings or finishes for each of the constituent materials encoded in Design Rule 1A 470. By selecting the potential coverings or finishes available to populate Design Rule 1B.1 475 based on the constituent materials encoded in Design Rule 1A 470, technical and manufacturing expertise may be included in the product attribute description process. For example, a manufacturer may know that certain types of chrome plating do not adhere well to certain material substrates. By encoding this expertise directly into the product attribute description process, product designers are able to electronically access a broad knowledge base during product design.

Referring to FIG. 5, the creation of a product definition may begin with copying of an existing product definition (step 510). This allows new versions of a product to be rapidly created, and common product attributes to be maintained across versions. The description of a new product in a product definition also may begin by creating a new, empty product definition. In either case, new product definition information may be added to the new or copied product definition (step 520). A new or existing product definition may also be populated using design rules (step 530).

Referring to FIG. 6, an exemplary product definition editor 600 includes a product definition navigation display 605, a product definition status display 610, a potential product attribute display 615, an applied product attribute display 620, and input structures 625, 630 to allow a user to edit product definitions.

Product definition navigation display 605 displays a navigation tree of existing product definitions. Product definition status display 610 displays the current status of a product definition selected in product definition navigation display 605. Status information may include information encoded in status record 410 including, for example, whether the product definition is complete, whether the product definition is retained or inactive, one or more reasons why the product definition is retained or inactive, and the names or status of other product definitions with the same geometry.

Potential product attribute display 615 includes a list of potential attributes 635, 640, 645, 650 to be added to a product definition to describe a product. Potential attribute 635 is a user-defined attribute titled “my_attribute” and may relate, for example, to highly specialized or a proprietary attribute of a product. The user may also define a range of potential attribute values or design rules for “my_attribute.” Potential attribute 640 is a standard attribute with an integer attribute value and titled “ug_integer_product_attrib.” Potential attribute 645 is a standard attribute with an numerical attribute value and titled “ug_number_product attrib.” Potential attribute 650 is a standard attribute with a string attribute value and titled “ug_string_product_attrib.” Potential attributes 635, 640, 645 may relate to common product attributes and may be predefined to define any of a number of different non-geometric characteristics of a product or product portion. User-defined attributes offer the flexibility needed to describe unusual products and product characteristics, while predefined attributes may be used to describe a product without delay.

Applied product attribute display 620 displays one or more product attributes in a product definition selected in product definition navigation display 605. Applied product attribute display 620 also displays an associated portion of the product geometry and attribute value information.

Input structure 625 includes product definition command inputs 655, 660, 665, 670, 675, and 680. Command input 655 initiates a command that results in creation of a new product definition. Command input 660 initiates a command that copies a selected product definition to create a new product definition in product definition navigation display 605. Command input 665 initiates a command that deletes a selected product definition in product definition navigation display 605. Command input 670 initiates a command that toggles the navigator tree in product definition navigation display 605 in and out of a hidden state. Command input 675 initiates a command that creates an indication in a display instance, for example, display instance 455 of FIG. 4, to indicate that a representation of the product should include a lead line between a selected product attribute and a portion of the product. Finally, command input 680 initiates a command that creates an indication in a display instance, for example, display instance 455 of FIG. 4, to indicate that a representation of the product should not include a lead line. Command inputs 675, 680 may also call up further input mechanisms that allow a user to define other characteristics for the display instances. For example, command inputs 675, 680 may be used to create or select symbols to be included in the selected product attribute.

Input structure 630 also includes product attribute command inputs 685 and 690. Command input 685 initiates a command that deletes a selected product attribute in applied product attribute display 620. Command input 690 receives a command that allows a user to edit a selected product attribute in applied product attribute display 620.

Finally, input structure 630 includes editor command inputs 595, 597, and 599. Command input 695 initiates a command that closes product definition editor 600 and saves any edits. Command input 697 initiates a command that applies a selected potential product attribute from potential product attribute display 615 to a product definition selected in product definition navigation display 605. The application of a potential product attribute has the effect of moving the potential product attribute from potential product attribute display 615 to applied product attribute display 620. Finally, command input 699 receives a command that closes product definition editor 600 without saving any edits.

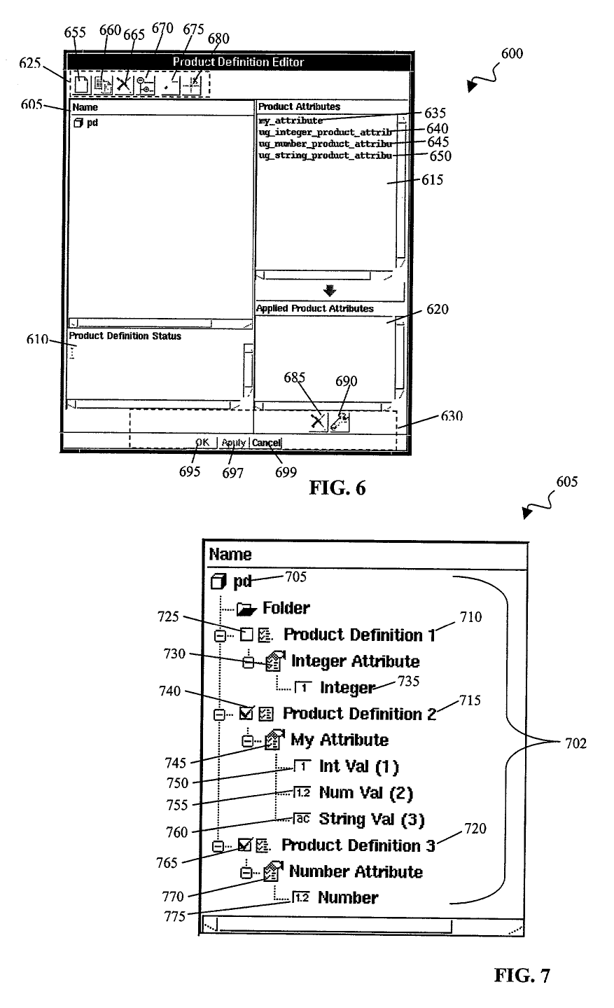

Referring also to FIG. 7, an exemplary navigation tree 702 of existing product definitions, suitable for display in product definition navigation display 605, includes a tree header 705 and three product definitions 710, 715, 720. Product definition 710 includes a empty display instance indicator 725 and a product attribute 730. Empty display instance indicator 725 indicates that product definition 710 lacks a display instance. Product attribute 730 is an integer product attribute and includes an integer attribute value 735.

Product definition 715 includes a display instance indicator 740 and a product attribute 745. Display instance indicator 740 indicates that product definition 715 includes a display instance, for example, display instance 455. Product attribute 745 is a user-defined product attribute and includes three different attribute values, namely integer attribute value 750, number attribute value 755, and string integer value 760.

Product definition 720 includes a display instance indicator 765 and a numerical product attribute 770. Display instance indicator 765 indicates that product definition 720 includes a display instance, for example, display instance 460. Product attribute 770 is a numerical product attribute and includes a number attribute value 775.

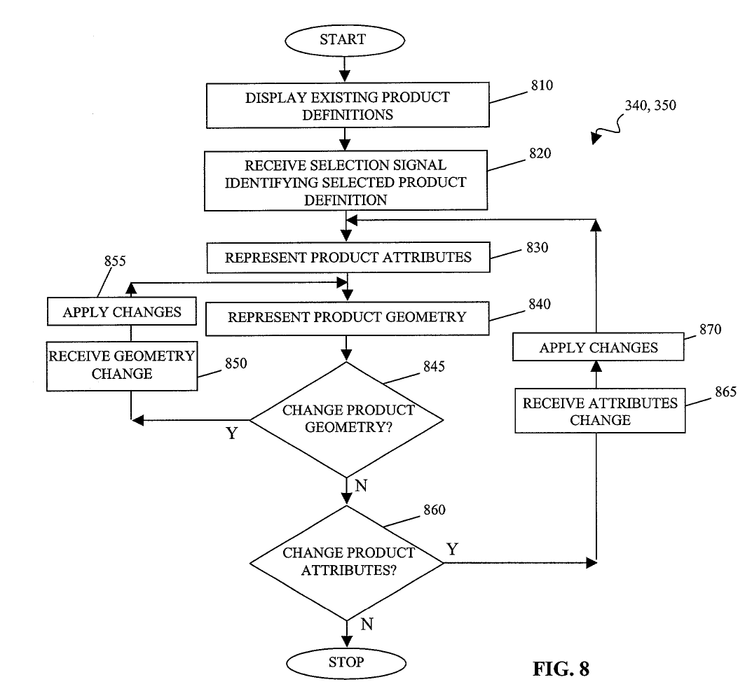

Referring to FIG. 8, a process flow 340, 350 for displaying and editing a representation of a product commences with the display of existing product definitions (step 810) and the reception of a selection signal that identifies one of the product definitions for representation (step 820). For example, the existing product definitions may be displayed in a list and the selected product definition may be highlighted by a user for display. A graphics module then represents the product attributes (step 830) and product geometry (step 840) for output to, for example, a monitor. If a user decides to change the product geometry (step 845), then the geometry changes are received (step 850) and applied to the product definition (step 855). The updated product geometry is then represented for output (step 840). It may not be necessary to again represent the product attributes (step 830), since these remain unchanged.

On the other hand, if a user decides to change the product attributes (step 860), then the attribute changes are received (step 865) and applied to the product definition (step 870). The updated product attributes are then represented for output (step 830), and process flow 340, 350 repeats until neither geometry changes nor attribute changes are desired by a user.

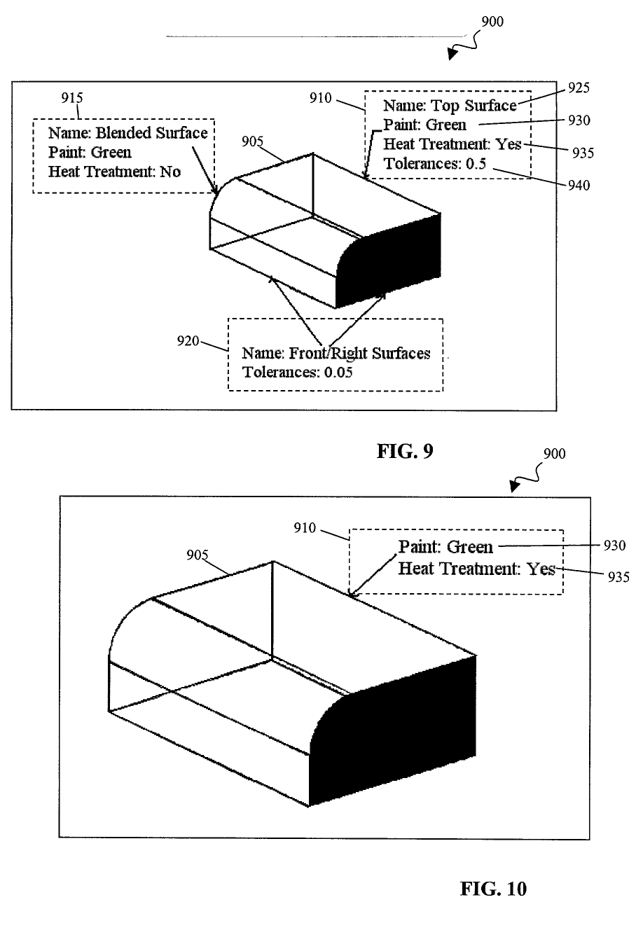

Product attribute changes can include changes to the attribute values as well as the display instances of a product attribute. For example, referring to FIG. 9, a product representation 900 includes a product geometry representation 905 and product attribute representations 910, 915, 920. Product attribute representation 910 includes a product description name 925, a product finish type and color 930, a product processing attribute 935, and a product tolerance attribute 940. Referring to FIG. 10, after editing, product attribute representations 915, 920 are no longer displayed in product representation 900, and product attribute representation 910 only includes a product finish type and color 930 and product processing attribute 935. The display instances of attribute representations 915, 920 have been changed so that they are no longer displayed, as have the display instances of product description name 925 and product tolerance attribute 940. The corresponding attribute values may or may not have been changed.

A number of implementations have been described. Nevertheless, it will be understood that various modifications may be made. Accordingly, other implementations are within the scope of the following claims.

What is claimed is:

1. A method of describing products in an electronically-accessible format, the method comprising:
receiving a product geometry description to describe the geometry of a portion of a product;
receiving a product attribute description to describe a non-geometric attribute of the portion of the product, the product attribute description being determined based on a design rule; and
storing the product geometry description and the product attribute description in an electronically-accessible format.

2. The method of claim 1 wherein the product attribute description comprises a numerical value of the non-geometric attribute described by the product attribute description.

3. The method of claim 2 wherein the design rule bounds a range of potential numerical values of the product attribute description.

4. The method of claim 1 wherein the design rule provides a list of potential product attribute descriptions.

5. The method of claim 1 wherein receiving the product attribute description comprises receiving a copy of a previous product attribute description.

6. The method of claim 5 wherein the previous product attribute description describes a non-geometric attribute of a previous version of the portion of the product.

7. The method of claim 1 wherein the product attribute description is determined based on the design rule and one of the product geometry description and another product attribute description.

8. The method of claim 1 further comprising electronically accessing the product attribute description.

9. The method of claim 8 further comprising using the electronically-accessed product attribute description to select a condition for manufacturing the portion of the product.

10. The method of claim 8 further comprising using the electronically-accessed product attribute description to select a process for manufacturing the portion of the product.

11. The method of claim 8 further comprising using the electronically-accessed product attribute description to select a tool for manufacturing the portion of the product.

12. The method of claim 1 further comprising:
receiving a second product attribute description to describe a second non-geometric attribute of the portion of the product; and
storing the second product attribute description in the electronically-accessible format.

13. The method of claim 1 further comprising:
receiving a second product geometry description to describe the geometry of a second portion of the product;
receiving a second product attribute description to describe a second non-geometric attribute of the second portion of the product; and
storing the second product geometry description and the second product attribute description in the electronically-accessible format.

14. The method of claim 13 further comprising:
receiving an edit to at least one of the product attribute description and the second product attribute description; and
incorporating the edit into the respective stored description.

15. The method of claim 1 further comprising displaying a status indicator to indicate that the portion of the product is inactive.

16. The method of claim 15 wherein displaying the status indicator to indicate that the portion of the product is inactive comprises displaying a reason as to why the portion of the product is inactive.

17. The method of claim 1 further comprising manufacturing the product based on the electronically-accessed product geometry description and the product attribute description.

18. A method of describing products in an electronically-accessible format, the method comprising:
receiving a product geometry description to describe the geometry of a portion of a product;
receiving a product attribute description to describe a non-geometric attribute of the portion of the product;
receiving a product attribute display instance to describe how the product attribute description is to be displayed;
storing the product geometry description, the product attribute description, and the product attribute display instance in an electronically-accessible format; and
basing a display of the product attribute description adjacent a product geometry display on the product attribute display instance.

19. The method of claim 18 further comprising changing the product geometry display while maintaining the display of the product attribute description.

20. The method of claim 18 further comprising:
receiving a second product attribute description to describe a second non-geometric attribute of the portion of the product; and
storing the second product attribute description in the electronically-accessible format.

21. The method of claim 20 further comprising displaying the second product attribute description adjacent the product geometry display.

22. The method of claim 21 further comprising removing one of the product attribute description and the second product attribute description from adjacent the product geometry display.

23. The method of claim 18 further comprising displaying a lead line between the product attribute description and the portion of the product.

24. The method of claim 18 further comprising displaying a status of the portion of the product.

25. A method of describing products in an electronically-accessible format, the method comprising:
receiving a product geometry description to describe the geometry of a portion of a product;
receiving a definition of a non-geometric attribute of the portion of the product from a user;
receiving a product attribute description to describe the non-geometric attribute; and
storing the product geometry description and the product attribute description in an electronically-accessible format.

26. The method of claim 25 further comprising receiving a second product attribute description to describe the non-geometric attribute of the portion of the product.

27. The method of claim 25 wherein receiving the definition of the non-geometric attribute comprises receiving a data class of the product attribute description of the non-geometric attribute.

28. The method of claim 25 wherein receiving the definition of the non-geometric attribute comprises receiving a design rule to determine the product attribute description of the non-geometric attribute.

29. A method of describing products in an electronically-accessible format, the method comprising:
receiving a product geometry description to describe the geometry of a portion of a product;
receiving a product attribute description to describe a predefined non-geometric attribute of the portion of the product; and
storing the product geometry description and the product attribute description in an electronically-accessible format.

30. The method of claim 29 wherein receiving the product attribute description to describe the predefined non-geometric attribute comprises receiving the product attribute description in a predetermined data class.

31. The method of claim 30 wherein receiving the product attribute description in the predetermined data class comprises receiving a string product attribute description.

32. A computer readable medium including instructions for causing a processor to:
receive a product geometry description to describe the geometry of a portion of a product;
receive a product attribute description to describe a non-geometric attribute of the portion of the product, the product attribute description being determined based on a design rule; and
store the product geometry description and the product attribute description in an electronically-accessible format.

33. The computer readable medium of claim 32 wherein the instructions cause the processor to determine the product attribute description using the design rule.

34. The computer readable medium of claim 32 wherein the product attribute description is determined based upon one of the product geometry description and another product attribute description.

35. The computer readable medium of claim 32 wherein the instructions cause the processor to electronically access the product geometry description and the product attribute description.

36. The computer readable medium of claim 25 wherein the instructions cause the processor to manufacture the product based on the electronically accessed product geometry description and product attribute description.

37. A computer readable medium including instructions for causing a processor to:
receive a product geometry description to describe the geometry of a portion of a product;
receive a product attribute description to describe a non-geometric attribute of the portion of the product;
receive a product attribute display instance to describe how the product attribute description is to be displayed;
store the product geometry description, the product attribute description, and the product attribute display instance in an electronically-accessible format; and
base a display of the product attribute description in a product attribute display adjacent a product geometry display on the product attribute display instance.

38. The computer readable medium of claim 37 wherein the instructions cause the processor to receive a definition of a non-geometric attribute of the portion of the product from a user.

39. The computer readable medium of claim 37 wherein the instructions cause the processor to change the product geometry display while maintaining the display of the product attribute description.

40. The computer readable medium of claim 37 wherein the instructions cause the processor to display a status of the portion of the product.

41. The computer readable medium of claim 40 wherein the instructions cause the processor to display an indicator to indicate that the portion of the product is complete.

42. The computer readable medium of claim 40 wherein the instructions cause the processor to display an indicator to indicate that the portion of the product is inactive.

43. A computer readable medium including instructions for causing a processor to:
receive a product geometry description to describe the geometry of a portion of a product;
receive a definition of a non-geometric attribute of the portion of the product from a user;
receive a product attribute description to describe the non-geometric attribute; and
store the product geometry description and the product attribute description in an electronically-accessible format.

44. A computer readable medium including instructions for causing a processor to:
receive a product geometry description to describe the geometry of a portion of a product;
receive a product attribute description to describe a predefined non-geometric attribute of the portion of the product; and
store the product geometry description and the product attribute description in an electronically-accessible format.
